(19) United States
(12) Patent Application Publication
(10) Pub. No.: US 2025/0386142 A1
(43) Pub. Date: Dec. 18, 2025

(54) Reinforced dome and Loudspeaker Using Same

(71) Applicant: AAC Microtech (Changzhou) Co., Ltd., Changzhou City (CN)

(72) Inventor: Chao Zhang, Changzhou (CN)

(21) Appl. No.: 19/230,045

(22) Filed: Jun. 5, 2025

Related U.S. Application Data
(63) Continuation of application No. PCT/CN2024/099603, filed on Jun. 17, 2024.

(51) Int. Cl. H04R 7/12

(52) U.S. Cl. CPC H04R 7/127; H04R 2307/023; H04R 2307/025; H04R 2307/027; H04R 2307/029

(57) ABSTRACT

The present application discloses a reinforced dome made of a raw material having a main material and a reinforcement material added to the main material, wherein the reinforcement material has a particle size of 1 nm to 5 μm, and the reinforcement material is added to the raw materials in a mass percentage of 1% to 50%. Compared to the domes made of pure polymer materials or metal materials in the related art, the reinforced dome of the present application improves the elastic modulus of the dome while ensuring the quality requirements of the dome, thereby enhancing the high-frequency performance of the loudspeaker product.

### TECHNICAL FIELD

The present application relates to the field of electroacoustic devices, and specifically to a reinforced dome used in a loudspeaker.

### BACKGROUND

In the prior art, the domes in loudspeakers are generally made of pure plastic or pure metal alloy materials. The resulting domes have a low elastic modulus, which is not conducive to improving the high-frequency performance of loudspeaker products.

Therefore, it is necessary to provide a dome with a higher elastic modulus and a loudspeaker with better high-frequency performance.

### SUMMARY

The object of the present application is to provide a reinforced dome and a loudspeaker. The reinforced dome has a higher elastic modulus, which can improve the high-frequency performance of the loudspeaker.

To achieve the above purpose, the present invention provides a reinforced dome made of a raw material comprising a main material and a reinforcement material added to the main material, wherein the reinforcement material has a particle size of 1 nm to 5 μm, and the reinforcement material is added to the raw materials in a mass percentage of 1% to 50%.

Further, the reinforcement material comprises one or more of reinforcement particles, reinforcement whiskers, reinforcement short fibers, or reinforcement long fibers; the reinforcement particles have a particle diameter of 1 nm to 5 μm, and the reinforcement whiskers, reinforcement short fibers, and reinforcement long fibers have a diameter of 5 nm to 1000 nm and an aspect ratio of 10 to 10000.

Further, the reinforcement material comprises one or more of carbides, borides, nitrides, metal oxides, non-metallic crystalline particles, carbon nanotubes, carbon nanofibers, or graphene.

Further, the carbides comprise one or more of silicon carbide, boron carbide, or titanium carbide; the borides comprise titanium boride; the nitrides comprise silicon nitride; the metal oxides comprise aluminum oxide; and the non-metallic crystalline particles comprise one or more of carbon, silicon, or graphite crystal particles.

Further, the main material comprises a metal material or a polymer material.

Further, the metal material comprises one or more of aluminum alloy, lithium alloy, magnesium alloy, or titanium alloy.

Further, the polymer material comprises one or more of polyetherimide, polyimide, or polycarbonate.

The present disclosure further provides a loudspeaker comprising a reinforced dome mentioned above.

The reinforced dome of the present application includes a main material and a reinforcement material added to the main material. By adding the reinforcement material to the main material, the mechanical properties of the dome are enhanced. Compared to the domes made of pure polymer materials or metal materials in the prior art, the reinforced dome of the present application improves the elastic modulus of the dome while ensuring the quality requirements of the dome, thereby enhancing the high-frequency performance of the loudspeaker product.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 shows a comparison of an Fr frequency response curves of a loudspeakers in Embodiment 2 and Comparative Example 1.

### DETAILED DESCRIPTION OF THE EMBODIMENTS

The following will be taken in conjunction with the accompanying drawings of embodiments of the present invention, The technical scheme in the embodiment of the invention is clearly and completely described, Obviously, the described embodiments are merely part of the embodiments of the present invention, and not all embodiments are based on the embodiments of the present invention, and all other embodiments attained by those of ordinary skill in the art without inventive effort are within the scope of the present invention.

### Embodiment 1

In a first aspect, an embodiment of the present application provides a reinforced dome. The raw materials for preparing the reinforced dome comprise a main material and a reinforcement material added to the main material. The reinforcement material has a particle size of 1 nm to 5 μm, and the reinforcement material is added to the raw materials in a mass percentage of 1% to 50%. The reinforced dome of the present application includes a main material and a reinforcement material added to the main material. By adding the reinforcement material to the main material, the mechanical properties of the dome are enhanced, forming an interface bonding in the reinforced dome. When the reinforced dome is subjected to external forces, the stress can be dispersed, improving the elastic modulus of the dome while ensuring the quality requirements of the dome, thereby enhancing the high-frequency performance of the loudspeaker product.

Specifically, in this embodiment, the particle size of the reinforcement material is preferably 1 nm to 5 μm. For example, the particle size of the reinforcement material can be 1 nm, 50 nm, 100 nm, 300 nm, 500 nm, 700 nm, 1 μm, 3 μm, or 5 μm. When the particle size is less than 1 nm, the reinforcement effect on the dome is not significant. When the particle size is greater than 5 μm, the reinforcement material tends to entangle in the main material, making dispersion difficult and affecting the ductility of the dome. The mass percentage of the reinforcement material added to the raw materials is preferably 1% to 50%. For example, the mass percentage of the reinforcement material can be 1%, 3%, 5%, 8%, 10%, 20%, 30%, 40%, or 50%. At this time, the reinforced dome can improve the elastic modulus while maintaining ductility.

Optionally, the reinforcement material comprises one or more of reinforcement particles, reinforcement whiskers, reinforcement short fibers, or reinforcement long fibers. Specifically, the reinforcement particles have a particle diameter of 1 nm to 5 μm, and the reinforcement whiskers, reinforcement short fibers, and reinforcement long fibers have a diameter of 5 nm to 1000 nm and an aspect ratio of 10 to 10000. It can be understood that when the reinforcement material is reinforcement particles, the particle size refers to the particle diameter of the reinforcement particles. When the reinforcement material is reinforcement whiskers, reinforcement short fibers, or reinforcement long fibers, the particle size refers to the length of the reinforcement whiskers, reinforcement short fibers, or reinforcement long fibers.

Optionally, the reinforcement material comprises one or more of carbides, borides, nitrides, metal oxides, non-metallic crystalline particles, carbon nanotubes, carbon nanofibers, or graphene. The reinforcement material can be sourced from known suppliers in the field or prepared by known methods. When carbon nanotubes are used as the reinforcement material, the carbon nanotubes can be standard products without functional groups or functionalized carbon nanotubes treated, for example, with acid. The carbon nanotubes may also have functional groups such as carboxyl, hydroxyl, or amino groups. The carbon nanotubes can be sourced from known suppliers in the field or prepared by known methods.

Optionally, the carbides comprise one or more of silicon carbide, boron carbide, or titanium carbide; the borides comprise titanium boride; the nitrides comprise silicon nitride; the metal oxides comprise aluminum oxide; and the non-metallic crystalline particles comprise one or more of carbon, silicon, or graphite crystal particles.

Optionally, the main material comprises a metal material or a polymer material. In use, the metal material or polymer material can be selected as described in the type of dome to be made and the audio quality requirements of the loudspeaker.

Optionally, the metal material comprises one or more of aluminum alloy, lithium alloy, magnesium alloy, or titanium alloy.

Optionally, the polymer material comprises one or more of polyetherimide, polyimide, or polycarbonate.

In a second aspect, the present application provides a loudspeaker comprising the reinforced dome as described above.

### Embodiment 2

The present application provides a loudspeaker comprising the reinforced dome as described above. Specifically, the reinforced dome has a thickness of 0.05 mm, and the reinforced dome comprises a main material and a reinforcement material, wherein the main material is aluminum alloy, and the reinforcement material has a particle size of 50 nm, with the reinforcement material added in an amount of 10% of the total mass of the raw materials.

### Comparative Example 1

Compared to Embodiment 2, the difference in Comparative Example 1 is that the reinforced dome of the loudspeaker in Comparative Example 1 is made of 5052 aluminum alloy with a thickness of 0.05 mm.

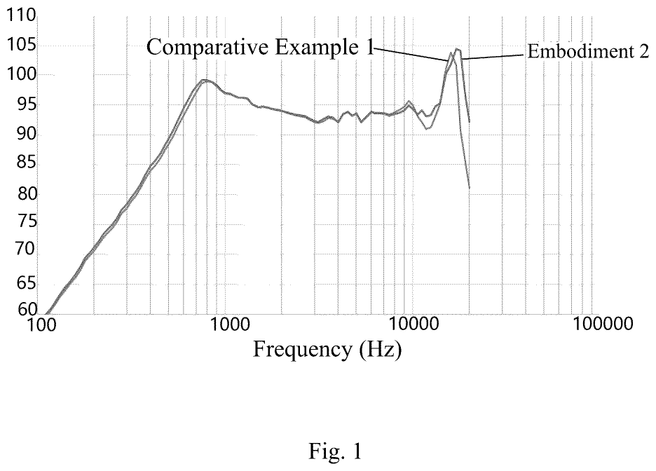

The loudspeakers of Embodiment 2 and Comparative Example 1 were subjected to Fr frequency response testing. As shown in FIG. 1, compared to Comparative Example 1, the loudspeaker of Embodiment 2 has reduced high-frequency distortion peaks and better high-frequency performance.

The foregoing is merely illustrative of embodiments of the present invention, and it should be noted that modifications may be made to those skilled in the art without departing from the spirit of the invention but are intended to be within the scope of the inventio.

What is claimed is:

1. A reinforced dome made of a raw material comprising a main material and a reinforcement material added to the main material, wherein the reinforcement material has a particle size of 1 nm to 5 μm, and the reinforcement material is added to the raw materials in a mass percentage of 1% to 50%.

2. The reinforced dome as described in claim 1, wherein the reinforcement material comprises one or more of reinforcement particles, reinforcement whiskers, reinforcement short fibers, or reinforcement long fibers; the reinforcement particles have a particle diameter of 1 nm to 5 μm, and the reinforcement whiskers, reinforcement short fibers, and reinforcement long fibers have a diameter of 5 nm to 1000 nm and an aspect ratio of 10 to 10000.

3. The reinforced dome as described in claim 1, wherein the reinforcement material comprises one or more of carbides, borides, nitrides, metal oxides, non-metallic crystalline particles, carbon nanotubes, carbon nanofibers, or graphene.

4. The reinforced dome as described in claim 3, wherein the carbides comprise one or more of silicon carbide, boron carbide, or titanium carbide; the borides comprise titanium boride; the nitrides comprise silicon nitride; the metal oxides comprise aluminum oxide; and the non-metallic crystalline particles comprise one or more of carbon, silicon, or graphite crystal particles.

5. The reinforced dome as described in claim 1, wherein the main material comprises a metal material or a polymer material.

6. The reinforced dome as described in claim 5, wherein the metal material comprises one or more of aluminum alloy, lithium alloy, magnesium alloy, or titanium alloy.

7. The reinforced dome as described in claim 5, wherein the polymer material comprises one or more of polyetherimide, polyimide, or polycarbonate.

8. A loudspeaker comprising a reinforced dome as described in claim 1.
